(19) United States
(12) Patent Application Publication
(10) Pub. No.: US 2007/0025345 A1
(43) Pub. Date: Feb. 1, 2007

(54) Method of increasing the capacity of enhanced data channel on uplink in a wireless communications systems

(76) Inventors: Rainer Walter Bachl, Nuremberg (DE); Anil M. Rao, Cedar Knolls, NJ (US); Mirko Schacht, Bavaria (DE); Henry Hui Ye, Ledgewood, NJ (US)

Correspondence Address: DOCKET ADMINISTRATOR;LUCENT TECHNOLOGIES INC., ROOM 2F-190, 600 MOUNTAIN AVENUE, MURRAY HILL, NJ, 07974-0636, US

(21) Appl. No.: 11/190,617

(22) Filed: Jul. 27, 2005

(51) Int. Cl. H04L 12/56

(52) U.S. Cl. 370/389; 370/473

(57) ABSTRACT

In a UMTS wireless communication system, when the packet size on the enhanced dedicated physical data channel (E-DPDCH) on the uplink from a UE to a NodeB reaches a converged default packet size, the corresponding dedicated physical control channel (E-DPCCH) is turned off. The NodeB uses the default packet size to decode the frame received on the E-DPDCH using each possible redundancy version. Alternatively, the E-DPCCH is turned off and a new transmission flag is transmitted by the UE only when a new frame is transmitted by the UE. NodeB then uses the presence or absence of that flag in conjunction with the absence of E-DPCCH to determine which redundancy version is to be assumed in decoding the frame received on E-DPDCH.

### TECHNICAL FIELD

This invention relates to wireless communications.

### BACKGROUND OF THE INVENTION

A wireless communications network typically includes a variety of communication nodes coupled by wireless or wired connections and accessed through different types of communications channels. Each of the communication nodes includes a protocol stack that processes the data transmitted and received over the communications channels. Depending on the type of communications system, the operation and configuration of the various communication nodes can differ and are often referred to by different names. Such communications systems include, for example, a Code Division Multiple Access 2000 (CDMA2000) system and a Universal Mobile Telecommunications System (UMTS).

Third generation wireless communication protocol standards (e.g., 3GPP-UMTS, 3GPP2-CDMA2000, etc.) may employ a dedicated traffic channel in the uplink (e.g., a communication flow between a mobile station (MS) or User Equipment (UE), and a base station (BS) or NodeB. The dedicated physical channel may include a data part (e.g., a dedicated physical data channel (DPDCH) in accordance with UMTS Release 4/5 protocols, a fundamental channel or supplemental channel in accordance with CDMA2000 protocols, etc.) and a control part (e.g., a dedicated physical control channel (DPCCH) in accordance with UMTS Release 4/5 protocols, a pilot/power control sub-channel in accordance with CDMA2000 protocols, etc.).

Newer versions of these standards, for example, Release 6 of UMTS provide for high data rate uplink channels referred to as enhanced dedicated physical channels. These enhanced dedicated physical channels may include an enhanced data part (e.g., an enhanced dedicated physical data channel [E-DPDCH] in accordance with UMTS protocols) and an enhanced control part (e.g., an enhanced dedicated physical control channel [E-DPCCH] in accordance with UMTS protocols). As defined in the specification of the enhanced uplink data channel, the UE transmits a frame of packet data in the E-DPDCH simultaneously with a frame of control information in the E-DPCCH channel. This control information communicated from UE to NodeB includes parameters that are in general necessary for NodeB to decode the E-DPDCH frame. An E-DPCCH word includes seven TFI (transport format indicator) bits that provide to the NodeB information from which NodeB can determine the size of the E-DPDCH data packet. This size information is needed because the packet size can vary based on the type of the application and the dynamic nature of packet data communication. Generally, two frame sizes (TTI lengths), i.e., 10 ms and 2 ms, are available for use in the E-DPDCH. In addition, an E-DPDCH word includes two RSN (retransmission sequence number) bits that indicate the redundancy version of the data packet. The redundancy version is needed because the NodeB needs to know whether a packet is a first transmission of a packet, or a HARQ (Hybrid Automatic Repeat Request) retransmission of the packet, and specifically whether it's a second, third or fourth transmission of the data packet. If a previous transmission has not been acknowledged by any of the NodeBs that might be communicating with a UE, the UE will retransmit the same packet unless an acknowledgement (ACK) is received from at least one NodeB, if it receives negative acknowledgements (NACKs) from all the NodeBs it is communicating with, or the maximum allowable number of retransmissions of the same packet has been reached. Therefore, even if a NodeB was not able to decode a packet transmission previously, it cannot predict whether the UE will send a new transmission of another data packet or the retransmission of the previous data packet since the previous data packet might have been acknowledged by another NodeB with which the UE was communicating. The E-DPCCH word also includes a single happy bit (H-bit), which indicates to the NodeB that the UE wants to transmit at a higher or lower rate. An E-DPCCH word is contains 10-bits.

The E-DPCCH is usually transmitted with sufficient power to guarantee that the NodeBs can decode this channel correctly. For UEs that transmit E-DPDCH with large data packets, the total power given to the E-DPCCH channel is only a small fraction of the power given to all E-DPDCH channels. However, for applications such a VolP (Voice-over-IP), the UEs transmit E-DPDCH with small data packets only. In this latter case, the power given to E-DPCCH is significant compared with the power given to the corresponding E-DPDCH packet of the same UE. There are also other situations where E-DPCCH power is significant compared to the E-DPDCH power, which is the case whenever UEs are transmitting with low data rates on E-DPDCH. In particular, very low data rates are often assigned to UEs with unfavorable path loss conditions in heavily loaded cells.

Disadvantageously, the additional power required for transmitting E-DPCCH can significantly reduce the overall capacity on the reverse channel. As noted, there are two different frame sizes (10 ms and 2 ms TTI lengths). For VolP applications, the 2 ms TTI length may be preferred since it introduces less delay as compared with the 10 ms TTI length, in particular when using a larger number of HARQ retransmissions leading to improved time diversity. The overhead due to E-DPCCH is even more significant for a 2 ms TTI length, however, because there is a higher effective E-DPCCH data rate and less diversity gain as compared to the case of a 10 ms TTI length.

### Summary of the Invention

In accordance with an embodiment of the present invention, the required E-DPCCH power is significantly reduced and the capacity for applications using the enhanced uplink data channel is thus greatly increased by reducing the amount of data being transmitted on the E-DPCCH when a predetermined condition is determined to be present the E-DPDCH.

In exemplary embodiments, for applications such as VolP where the data rate usually does not change and remains constant, there is no need for the UE to notify the NodeB of the E-DPDCH packet size for every E-DPDCH frame transmission, as the information carried on E-DPCCH becomes redundant. However, in the initial stage of the communication between NodeB and UE, the E-DPDCH packet size can still vary due to a lack of so called “robustness” of the transmission. Once the robustness has been achieved, the packet size will converge to a value that corresponds to the specific application being run (such as VolP with a particular data rate). Once a converged packet size on the E-DPDCH has been reached, referred to hereinafter as the “default packet size”, the amount of data transmitted on the E-DPCCH is reduced.

In a first embodiment, when the corresponding E-DPDCH packet size matches the default packet size, which is the case when robustness is achieved, the E-DPCCH is totally turned off. When the E-DPCCH is turned off, the NodeB will know to use the default packet size. It is, however, blind as to whether UE is transmitting a new data packet or retransmitting a previously transmitted data packet. NodeB thus needs to decode each data packet multiple times based on all the possible redundancy versions for the currently received TTI. If the maximum number of transmission of a data packet is N, NodeB will decode each E-DPDCH data packet up to N times for each assumed transmission or retransmission, and will stop when the decoding succeeds with a good CRC check or when all N trials have failed.

In a second exemplary embodiment of the present invention, when the corresponding E-DPDCH packet size matches the default packet size, the E-DPCCH is again switched off but a new-transmission flag of minimum bit length, such as a single bit flag, is transmitted by the UE to NodeB only when a new E-DPDCH frame is transmitted. Thus, if NodeB does not detect the E-DPCCH transmission, but does detect the new-transmission flag, it uses the default packet size and assumes the transmission on the E-DPDCH to be a new transmission (a redundancy version equal to 0). If NodeB does not detect the E-DPCCH transmission or the new-transmission flag, it adds one to the previous redundancy version and attempts to decode E-DPDCH. The new-transmission flag can be transmitted from UE to NodeB by either adding a specific code word on the current E-DPCCH or by means of a separate physical code channel.

### BRIEF DESCRIPTION OF THE DRAWING

FIG. 1 is a block diagram showing a UE communicating on the uplink on the E-DPDCH and E-DPCCH with two NodeBs in a soft handoff situation, in accordance with the prior art;

FIG. 2 shows the prior art timing relationship between E-DPCCH, E-DPDCH, and the ACK/NACK received by NodeB in response to an E-DPDCH transmission;

FIG. 3 shows the timing relationship between E-DPCCH, E-DPDCH, and the ACK/NACK received by NodeB in response to an E-DPDCH transmission in accordance with a first embodiment of the present invention; and

FIG. 4 shows the timing relationship between a new-transmission flag, E-DPCCH, E-DPDCH, and the ACK/NACK received by NodeB in response to an E-DPDCH transmission in accordance with a second embodiment of the present invention.

### DETAILED DESCRIPTION

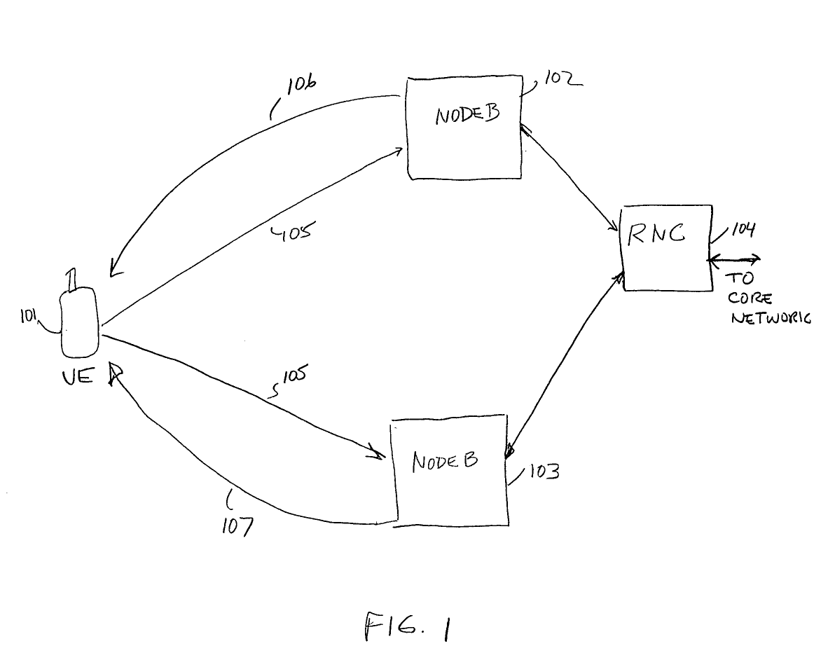

With reference to FIG. 1, UE 101 is shown communicating on the enhanced data channel in a soft handoff situation with both NodeB 102 and NodeB 103. NodeB 102 and NodeB 103 are illustratively shown connected to the same multi-NodeB (or multi-base station) controller 104, referred to herein and in UMTS terminology as an RNC (Radio Network Controller). For clarity purposes, connections of RNC 104 to the core network are not shown, but are understood to exist by those skilled in the art. The transmissions labeled 105 indicate that UE 101 is sending a packet on the uplink through E-DPDCH and E-DPCCH to NodeBs 102 and 103. Both NodeBs 102 and 103 independently attempt to decode the E-DPDCH and E-DPCCH transmissions. If the E-DPDCH packet is successfully decoded by either NodeB 102 or NodeB 103, the NodeB that decodes the packet sends a positive acknowledgment (ACK) to UE 101 by either transmission 106 from NodeB 102 or transmission 107 from NodeB 103. If UE 101 receives an ACK from either NodeB 102 or NodeB 103, it thereafter transmits a new data packet. If UE 101 receives negative acknowledgments (NACKs) from both NodeBs 102 and 103, it will retransmit the same data packet. The retransmission procedure for that packet is terminated when either an ACK is received from one of the NodeBs, or the maximum allowable number of retransmission is reached.

FIG. 2 shows the exemplary timing diagram for the E-DPDCH and E-DPCCH transmission and retransmission procedure as defined in the current art (3GPP Release 6 Standard). The timing diagram is for a 10 ms TTI, but what is described is equally applicable to a 2 ms TTI as would most likely be used for VolP. As can be noted, the E-DPDCH transmission is always accompanied by a corresponding E-DPCCH transmission. As previously noted, each E-DPCCH word includes three pieces of information: the RSN (retransmission sequence number), the TFI (transport format indicator), and an H-bit (a Happy bit), for a total of 10 bits. When the UE starts a new packet transmission 201 on E-DPDCH in frame 0, indicated by “1^{st} TX”, the corresponding E-DPCCH transmission 202 is made on the uplink. Assuming for illustration that UE receives NACKs 203 from all NodeBs in frame 2, an E-DPDCH retransmission 204 (2^{nd} TX) of that same packet is made in frame 4, again accompanied by a corresponding E-DPCCH transmission 205. In this example, the UE still receives NACKs 206 in frame 6, which indicate the transmission in frame 4 has failed. Therefore, another E-DPDCH retransmission 207 (3^{rd} TX) and accompanying E-DPCCH transmission 208 are made in frame 8. In this example, the E-DPDCH transmission 207 is successfully received and, in frame 10, an ACK 209 is transmitted by the NodeB back to the UE. Upon receiving the ACK response, the UE makes a new data packet E-DPDCH transmission 210 and accompanying E-DPCCH transmission 211 in frame 12.

The capacity for those applications using the enhanced data channel on the uplink is increased by reducing the required E-DPCCH power for applications such as VolP where the data rate usually does not change and remains constant. For example, the data rate for a VolP user can be determined by that user's specific vocoder. As a result, the E-DPDCH packet size is also constant in general and its specific size is vocoder dependent. In this case, there is no need for the UE to notify the NodeB of the E-DPDCH packet size for every E-DPDCH frame transmission, as the information carried on E-DPCCH becomes redundant.

In the initial stage of communication between NodeB and UE, the E-DPDCH packet size can still vary due to a lack of the so called “robustness” of the transmission. Once the robustness has been achieved, the packet size will converge to a value that corresponds to the specific application, such as VoIP with a particular data rate. In accordance with 3GPP Release 5 and Release 6 standards, usage of robust header compression (ROHC, RFC 3095) is specified. Here, the header size of initial packets will be large, i.e., uncompressed. After the compression context has been established at the receiver, only a minimum header is transmitted with constant size, typically three bytes. Although mechanisms for header updates are specified, it can be anticipated that for VolP applications, the header size will not change once the highest compression state is reached. As previously noted, the converged packet size is referred to hereinafter and in the claims as the “default packet size.” The embodiments of the present invention described herein are applicable to applications such as VolP, but not limited to VolP, where the E-DPDCH default packet size is known. It is noted that certain modes of ROHC, such as O-mode and R-mode, make use of feedback in the header so that the decompressor can indicate state information to the compressor. In these cases the header size will vary from the minimum size by an additional two bytes. The assumption can be made herein that padding bits are added to the minimum packet size such that there is no difference between the total VolP packet size when there is feedback in the RoHC header; hence, the use of feedback will not change what is referred to as the “default packet size.”

In accordance with a first exemplary embodiment, the E-DPCCH is completely switched off whenever the corresponding E-DPDCH packet size matches the default packet size, which is the case once robustness is achieved. Advantageously, switching off the E-DPCCH significantly improves the air interface capacity. While E-DPCCH is switched off, the UE can also be in a handoff situation from a first NodeB to a second. The second NodeB may be able to determine the default E-DPDCH packet size based on the specific application and can thus assume the default size for E-DPDCH whenever it is unable to decode the E-DPCCH channel. Alternatively, a mechanism could be introduced in the RNC that informs NodeBs of the default packet size for a particular UE and HARQ process whenever a particular NodeB is added to the active set for that UE. This requires a change in the standards as the signaling of the default packet size is not currently supported in the current standard specifications. With the advantages of increased capacity for VolP-like applications, such a change in standards would likely be accepted.

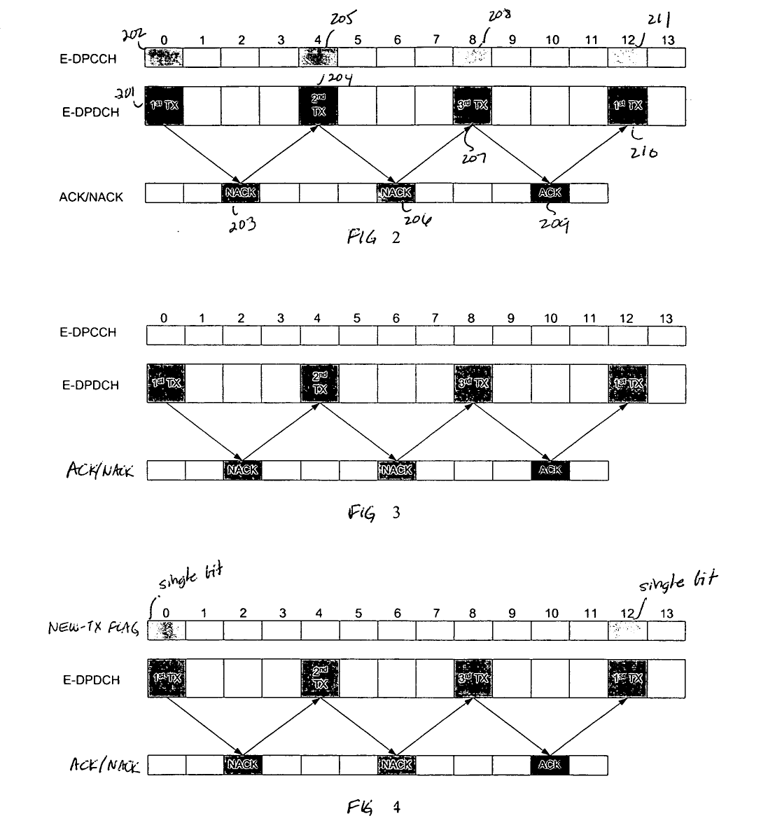

FIG. 3 shows a modification the timing diagram of FIG. 2 in accordance with this first embodiment where E-DPCCH is totally turned off when the E-DPDCH packet size has reached the default packet size for a VolP-like application. As was noted above, this timing diagram, as in FIG. 2, is for a TTI of 10 ms but is equally applicable when TTI is equal to 2 ms.

When E-DPCCH is totally switched off as per this first embodiment, NodeB processing by necessity becomes more complicated. As previously noted, the two most important parameters values the E-DPCCH channel conveys to NodeB are packet size and redundancy version. While the NodeB knows to use the default packet size for VolP-like applications when the E-DPCCH is switched off, it remains blind on whether UE is transmitting a new data packet or retransmitting a previously transmitted data packet. Therefore, NodeB needs to decode each data packet received on E-DPDCH multiple times based on all the possible redundancy versions for the currently received TTI. Assuming, for example, that the maximum allowable number of transmissions (original transmission and retransmissions) for a VolP user's data packet is N (i.e., up to N−1 retransmissions allowed), the NodeB needs to decode each E-DPDCH data packet up to N times: first decoding the data packet assuming that it is a new transmission; if it fails, then decoding the data packet assuming that it is a first retransmission; etc.; and finally, decoding the data packet assuming that it is the (N−1)th retransmission if all the preceding effort failed. This procedure stops either when the decoding succeeds with a “good” CRC check, or when all N attempts to decode the packet have failed.

Implementing this multiple-decoding scheme within NodeB increases decoding complexity by up to N times. In practice, N has the value in the range of 2-4 or 2-6. Provided the E-DPCCH is switched off for UEs where the data packet sizes are small in general, requiring N times more decoding capability for those UEs may only increase the overall NodeB implementation complexity for the decoding by some low percentage.

A summary of this embodiment is as follows:

For UEs with applications where the E-DPDCH data rate is constant and the default E-DPDCH packet size is known, the UE will switch off the E-DPCCH transmission whenever the corresponding E-DPDCH packet size is equal to the default packet size. Since the E-DPDCH packet size will converge to the default packet size after the initial period, the E-DPCCH is then switched off most of the time and therefore the air interface resource consumed by E-DPCCH is significantly reduced.

The NodeB will try to detect and decode E-DPCCH all the time as in the prior art. If it can detect and decode an E-DPCCH transmission, it uses the packet size and redundancy information from the decoded E-DPCCH to decode the corresponding simultaneously transmitted E-DPDCH frame. However, if E-DPCCH cannot be detected, the NodeB assumes the default packet size has been used by the UE and attempts to decode the received E-DPDCH frame multiple times based on all possible redundancy version numbers for the most recently received E-DPDCH frame.

The standard needs to be changed (1) for signaling the default data packet size to NodeBs added to a particular UE's active set; and (2) for switching off the E-DPCCH whenever the corresponding E-DPDCH packet size is equal to the default packet size.

A second exemplary embodiment avoids the need to decode E-DPDCH multiple times in the NodeB. In accordance with this embodiment, E-DPCCH is turned off whenever the corresponding E-DPDCH packet size is equal to the default packet size and, in addition, a one-bit “new transmission” flag (new-tx flag) is transmitted when a new E-DPDCH frame is transmitted while E-DPCCH is switched off.

Node B functions thus functions as follows: if NodeB detects the E-DPCCH transmission but not the new-tx flag, the redundancy version and packet size information from the decoded E-DPCCH frame are used to decode E-DPDCH; if Node B does not detect the E-DPCCH transmission but detects a new-tx flag, it uses the default packet size and a redundancy_version=0 to decode the E-DPDCH frame; if NodeB doesn't detect E-DPCCH or a new-tx flag, it uses the default packet size and redundancy_version=previous redundancy_version+1 to decode the E-DPDCH frame, meaning that NodeB always uses the last detected new-tx flag to synchronize with the redundancy version as used by the UE.

FIG. 4 shows the timing relationship between E-DPCCH, the one-bit new-tx flag, E-DPDCH, and the ACKs/NACKs received by the UE in accordance with the second embodiment. As can be noted, E-DPCCH is turned off. The single-bit new-tx flag is transmitted only during frames 0 and 12 when E-DPDCH is simultaneously making a new transmission. No flag and no E-DPCCH are transmitted during frames 4 and 8 when second and third transmissions of the E-DPDCH frame are made in response to receiving NACKs in frames 2 and 6, respectively.

As compared with the first embodiment, the second embodiment simplifies the NodeB implementation by eliminating the need to decode the same E-DPDCH frame multiple times at the expense of consuming minimum air interface resources to transmit the new-tx flag. The new-tx flag could be transmitted from UE to NodeB by either adding a specific code word on the current E-DPCCH or by means of a separate physical code channel. Power consumption for transmitting a single bit only for new transmissions is significantly less than the power consumption for transmitting a 10-bit E-DPCCH frame with each E-DPDCH frame, as per the prior art. Thus, the new-tx flag transmission uses much less resources than are required for E-DPCCH transmission.

A summary of the second embodiment is as follows:

The UE's behavior is identical to that described in conjunction with the first embodiment above except that a one-bit new-tx flag is sent to NodeB whenever E-DPCCH is switched off and an E-DPDCH data packet is transmitted for the first time.

NodeB detects whether it receives a new-tx flag and whether a regular E-DPCCH has been transmitted by the UE. If E-DPCCH is detected, NodeB uses the packet size and redundancy version information from the decoded E-DPCCH transmission. If a new-tx flag is detected, NodeB uses it to synchronize the redundancy version with the UE and assumes the default packet size for E-DPDCH. If neither a new-tx flag nor E-DPCCH is detected, NodeB assumes the default packet size for E-DPDCH and derives the redundancy version from the previously detected E-DPCCH or new-tx flag.

The standard needs to be changed (1) for signaling the default packet size, (2) for switching off the E-DPCCH whenever the corresponding E-DPDCH packet size is equal to the default packet size, and (3) for introducing the new-tx flag.

The Happy (H) bit is typically not used for applications such as VolP, which is delay sensitive. Thus, turning E-DPCCH off and not providing that information when the default packet size is being transmitted on E-DPDCH will not have a deleterious effect.

Although described above in conjunction with embodiments that are in accord with UMTS standards, the present invention could be applicable to other wireless standards in which a high-speed data packet channel and accompanying control channel are transmitted on the uplink or downlink between a mobile terminal and a base station or similar device, as for example wireless systems that are in accord with EVDO standards, WiMAX standards, or other standards that have been adopted or proposed, or standards that have not yet been adopted or proposed.

Accordingly, the above described embodiments are merely illustrative of the principles of the present invention. Other embodiments could be devised by those skilled in the art without departing from the spirit and scope of the present invention.

The invention claimed is:

1. A method in a wireless communication system comprising the step of:
if a predetermined condition of data being transmitted on a dedicated physical data channel is determined to be present, reducing the amount control information transmitted on a dedicated physical control channel that is associated with the dedicated physical data channel, which control information is used for decoding the data on the dedicated physical data channel.

2. The method of claim 1 wherein if the predetermined condition is determined to be present on the dedicated physical data channel, transmitting no control information on the associated dedicated physical control channel.

3. The method of claim 1 wherein if the predetermined condition is determined to be present on the dedicated physical data channel, transmitting a flag in association with a packet transmitted on the dedicated data channel when that packet is a new packet.

4. The method of claim 3 wherein the flag is transmitted on the associated dedicated physical control channel.

5. A method in a wireless communication system comprising the step of:
if the size of data packets being transmitted on a dedicated physical data channel matches a default data packet size, reducing control information transmitted on a dedicated physical control channel that is associated with the dedicated physical data channel, which control information is used for decoding the data packets received on the dedicated physical data channel.

6. The method of claim 5 wherein if the size of the packets being transmitted on the dedicated physical data channel matches the default data packet size, transmitting no control information on the associated dedicated physical control channel.

7. The method of claim 5 wherein if the size of the packets being transmitted on the dedicated physical data channel matches the default data packet size, transmitting a flag in association with a packet transmitted on the dedicated data channel when that packet is a new packet.

8. The method of claim 7 wherein the flag is a single bit and is transmitted only when the packet transmitted on the dedicated data channel is a new packet and is not transmitted when the packet is a retransmission of a previously transmitted packet.

9. The method of claim 7 wherein the flag is transmitted on the associated dedicated physical control channel.

10. The method of claim 7 wherein the flag is transmitted on a separate channel.

11. The method of claim 5 wherein the dedicated physical data channel is the enhanced dedicated physical data channel (E-DPDCH) and the dedicated physical control channel is the associated enhanced dedicated physical control channel (E-DPCCH) that are both transmitted on the uplink in a Universal Mobile Telecommunications System (UMTS).

12. A method in a wireless communications system comprising the step of:
if a packet is received on a dedicated physical data channel and corresponding control information is not received on a dedicated physical control channel that is associated with the dedicated physical data channel and which control information if present would be used for decoding the data on the dedicated physical data channel, using a default data packet size to decode the received packet.

13. The method of claim 12 further comprising the step of:
attempting to decode the received packet for each possible redundancy version of the received packet.

14. The method of claim 12 further comprising the step of receiving the default data packet size before decoding the received packet.

15. The method of claim 12 further comprising the step of:
if a packet is received on the dedicated physical data channel and corresponding control information is not received on the associated dedicated physical control channel and a flag representing a new packet transmission is received in association with the received packet, then using the default data packet size to decode the packet with an assumed redundancy version equal to zero.

16. The method of claim 12 further comprising the step of:
if a packet is received on the dedicated physical data channel and corresponding control information is not received on the associated dedicated physical control channel and a flag representing a new packet transmission is not received in association with the received packet, then deriving a redundancy version of the received packet from a previously detected flag and using the default data packet size in combination with the derived redundancy version to decode the packet.

17. The method of claim 12 wherein the dedicated physical data channel is the enhanced dedicated physical data channel (E-DPDCH) and the dedicated physical control channel is the associated enhanced dedicated physical control channel (E-DPCCH) both transmitted on the uplink in a Universal Mobile Telecommunications System (UMTS).
